(19) United States
(12) Patent Application Publication
(10) Pub. No.: US 2009/0259962 A1
(43) Pub. Date: Oct. 15, 2009

(54) Character Input Method

(76) Inventor: Marc Ivor John Beale, Suckley (GB)

Correspondence Address: Ira S Dorman, 330 Robert Street, Suite 220, East Hartford, CT, 06108, US

(21) Appl. No.: 12/225,021

(22) PCT Filed: Mar. 7, 2007
(86) PCT No.: PCT/GB2007/000802

§ 371 Date: Dec. 11, 2008

(30) Foreign Application Priority Data
Mar. 17, 2006 (GB) 0605386.2

(51) Int. Cl. G06F 3/048

(52) U.S. Cl. 715/773; 715/261

(57) ABSTRACT

A method is provided for inputting characters to an electronic device having a virtual keyboard displayed on a screen. The method includes the step of displaying a plurality of character entry regions (1). Each region is adapted to display either, at a first level, a plurality of character options, or, at a second level, a single character option from the plurality of character options from a previously selected region. The number of regions and the number of characters is such that a desired character option can always be selected with no more than two keystrokes.

This invention relates to a method of inputting characters to an electronic device having a virtual keyboard displayed on screen.

The input of characters into small-scale computing devices, such as personal digital assistants and other hand-held computing devices can be difficult to accomplish manually due to the small size of the keys. Additionally for disabled users of personal and other computers it can be difficult or impossible to enter data from a keyboard. Whilst it may in some cases be possible to reproduce the layout of a standard keyboard on a computer screen, where the device is small, or where the user may have an impaired ability to control movement of a cursor or the like across the screen, or where the control means for the cursor has limited accuracy (such as a gaze direction tracker), the selection of an individual key can be difficult or impossible.

It is therefore desirable in certain circumstances to be able to provide a method of inputting characters which involves a reduced number of keys so as to simplify the selection of the desired key. While the presentation of a reduced number of keys may require additional keystrokes, such an arrangement is often desirable where space is limited or where the user is disabled.

Keystroke disambiguation is a well-known method of reducing the number of keys required. However, this method can have the disadvantage of restricting the user to words found in the system's memory.

Inputting characters with a reduced number of keys is known. However, the methods employed are clumsy and require several key selections to be made before a desired character can be selected. Moreover, the characters appear in different positions from time-to-time, for example based on previous character selections, which makes it difficult to predict where a desired character may appear.

Consequently, it is an object of the present invention to provide a method of inputting characters to an electronic device having a virtual keyboard displayed on a screen and which enables the selection of a desired character in a quick and efficient manner.

According to the present invention there is provided a method of inputting characters to an electronic device having a virtual keyboard displayed on a screen, the method comprising:

displaying a plurality of character entry regions, each region being adapted to display either:
at a first level a plurality of character options; or
at a second level a single character option from the plurality of character options from a previously selected region,

the number of regions and the number of characters being such that a desired character option can always be selected with no more than two keystrokes.

It will be understood that the term “keystroke” as used herein represents a number of alternative ways of selecting the contents of a character entry region. For example, a character entry region may be selected by contacting the region with a stylus, finger or other means (that is with a touch screen), or a character entry region may be selected with a gaze direction tracker, or a character entry region may be selected with a mouse, touchpad, joystick, trackball, keypad or switch access, such as provided for software designed for users with disabilities. Clearly the skilled person will be aware of further means by which a character entry region may be selected. The present invention is particularly useful when used in combination with a personal computer and a gaze direction tracker. The virtual keyboard needs only to occupy a small region of the screen and allows the entry of any combination of symbols.

The term “character option” may include more than one symbol which is to be selected with a single keystroke, such as the possessive case where the character option may be, for example, an apostrophe followed by the letter s ('s).

After a desired character option has been selected the virtual keyboard may revert to a display in which each region is adapted to display a plurality of character options.

The character options at the first level may always be displayed in the same arrangement. The character options at the second level may always be displayed in the same arrangement in dependence upon the character selected at the first level.

The virtual keyboard may display further character entry regions for displaying one or more predicted words or phrases for selection by a user. The further character entry regions may be activated at the second level and may be activated at the first level after a first character has been selected. The further character entry regions may be located above the first-mentioned character entry regions.

The virtual keyboard may include a character display region for displaying character options selected by a user. The character display region may be located above the character entry regions.

The character entry regions may be arranged in an array such as four rows of regions with four regions in each row, eight rows with two regions in each row, or two rows with eight regions in each row.

For a better understanding of the present invention and to show more clearly how it may be carried into effect reference will now be made, byway of example, to the accompanying drawings in which:

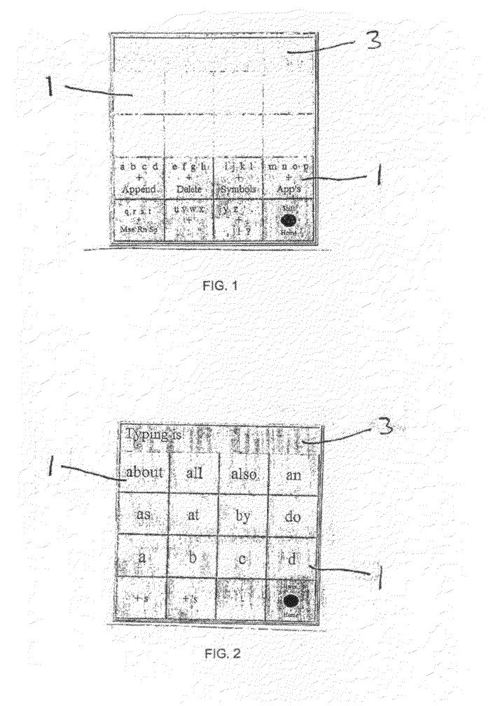

FIG. 1 is an illustration of one embodiment of a first level of a virtual keyboard for effecting the method of the present invention;

FIG. 2 is an illustration of one embodiment of a second level of a virtual keyboard for effecting the method of the present invention;

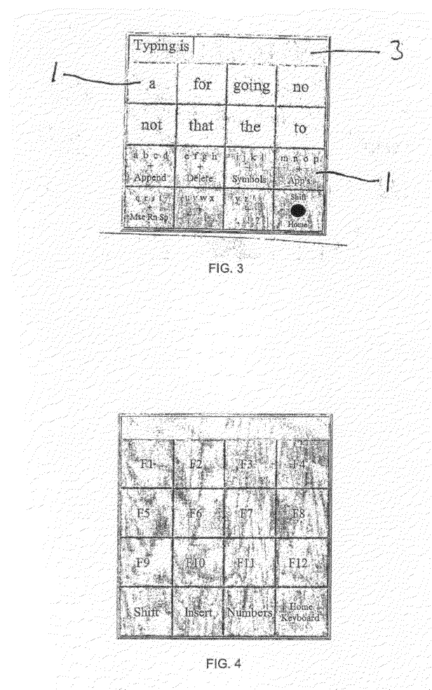

FIG. 3 is an illustration of another embodiment of a first level of a virtual keyboard for effecting the method of the present invention;

FIGS. 4 to 6 illustrate how character entry regions of the virtual keyboard can be used for other purposes.

The first level of a virtual keyboard shown in FIG. 1 comprises a number of character entry regions 1, not all of which may be in use at all times. As can be seen from FIG. 1 the character entry regions 1 are arranged in a square of four regions (or keys) by four regions (or keys), of which in the initial configuration only the two lower rows are in use with the two upper rows being blank. Above the top row of character entry regions I is a rectangular text display region 3 for displaying text or other symbols entered by the user.

Most of the two lower rows of character entry regions display in the initial configuration a plurality of character options together with one or more further options, however one or more special regions may be provided for particular functions such as “shift” or “home”. In this first level display, the character options are always displayed in the same arrangement.

In order to select a character, from the initial configuration of the first level keyboard the user selects, using any convenient means known to the skilled person, one of the character entry regions from the two lower rows and the display then changes to a second level of the virtual keyboard. For example, if the character entry region at the left hand side of the next-to-bottom row is selected (the primary characters being a, b, c and d) the display changes to the second level virtual keyboard shown in FIG. 2 in which the characters a, b, c and d are to be found in separate character entry regions together with a number of further options depending on the number of character entry regions available. In this way, it is always possible to select any one of the characters a, b, c or d in no more than two keystrokes. In this second level keyboard, again the character options are always displayed in the same arrangement. This ensures the user becomes familiar with the keyboard layouts. If a different character entry region is selected, the display changes accordingly, but it is always possible to select any individual character within two keystrokes and the character options are always displayed in the same arrangement.

As can be seen from FIG. 2, in a second level virtual keyboard each character entry region 1 in the lower two rows contains a single character option which can be selected unambiguously, such as a single letter or the option to add a plural or possessive character. As explained above, this character option is always displayed in the same character entry region. One or more of the character entry regions in the upper two rows offers a predicted word or phrase. The manner in which a word or phrase is predicted is well known to the skilled person and is not described in more detail herein. The predicted word or phrase displayed in any one character entry region may well change with time, depending, for example, on the words or phrases used historically. Frequently used phrases may be abbreviated or represented by an acronym, but may be expanded by the system to their full text, if selected. Once a particular character entry region is selected, the appropriate text is displayed in the rectangular text display region 3 above the rows of character entry regions and the display returns to a first level virtual keyboard displaying a plurality of character options in each character entry region 1 of the lower two rows. However, because character entry is now underway, in addition to the plurality of character options in the lower two rows, it is possible to offer a predicted word or phrase in one or more of the character entry regions of the upper two rows as shown in FIG. 3. As explained above, the character options in the lower two rows are always displayed in the same spatial locations to enable a user to become familiar with the layout, while those in the upper two rows may change with time.

Although in general it is necessary for a user to make (at most) two selections to enter a single letter, this is not as inefficient as might at first appear because it enables the overall number of keys to be reduced and, once character entry is under way, the use of word or phrase prediction significantly reduces the number of selections required. Although it is not essential, the use of word or phrase prediction creates a highly efficient typing system in which both the number of keys and the number of keystrokes can be reduced compared with a conventional typing system, while allowing any combination of symbols to be selected.

Although the number of character entry regions can be varied as can the number of rows and columns, it has been found that the use of eight character entry regions for first disambiguating the character option to be selected and subsequently for offering a suitable number of character options for selection is highly effective, especially when arranged in two rows of four regions. It has also been found that such a combination together with eight predicted words or phrases, again ideally arranged in two rows of four regions, is particularly effective. As an alternative, four rows of two regions, together with a further four rows of two regions for predicted words or phrases arranged above the regions for character options has been found to be effective. As a further alternative, a single row of eight regions with a further single row of eight regions for predicted words or phrases arranged above the regions for character options has also been found to be effective.

In order to reduce the likelihood of erroneous predictions, a character option may be provided for undoing a selection just made so as to return the system to its state immediately prior to the last character selection so as to be able to reverse, for example, an erroneous or inadvertent selection.

The ordinary skilled person would appreciate that speech synthesizer software may be incorporated into the system in order to convert the user's text into speech. This enables the system to be used as a voice output communication aid.

The character options may include options commonly provided on a computer keyboard, such as Control, Alt and Shift keys, thereby allowing a user to carry out the functions of a personal computer such as saving and opening files. Such character options can be presented as they would be with a personal computer, such as a layered menu, but without multiple options in a single character input region.

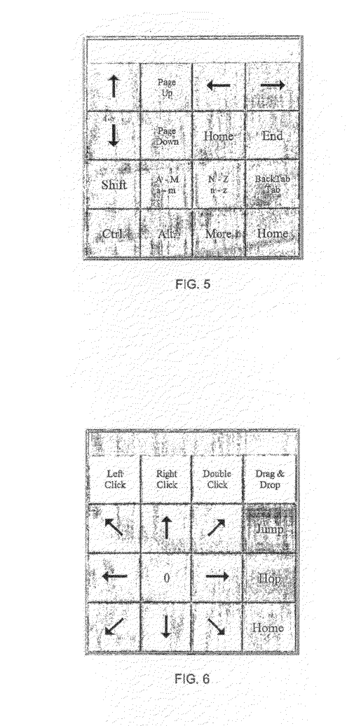

In addition to character entry, the regions 1 may be employed for other purposes such as the function keys of a conventional PC keyboard (see FIG. 4), other PC control keys (see FIG. 5) and cursor control keys (see FIG. 6).

1. A method of inputting characters to an electronic device having a virtual keyboard displayed on a screen, the method comprising: displaying a plurality of first character entry regions (1), each region being adapted to display either:
at a first level a plurality of character options; or
at a second level a single character option from the plurality of
character options from a previously selected region, the number of regions and the number of characters being such that a desired character option can always be selected with no more than two keystrokes, wherein the method further comprises displaying a plurality of second character entry regions (1) for displaying, after a first character has been selected, at the first level one or more predicted words or phrases for selection by a user.

2. A method according to claim 1, wherein after a desired character option has been selected the virtual keyboard reverts in the first character entry regions to a display in which each region (1) is adapted to display a plurality of character options.

3. A method according to claim 1, wherein the character options at the first level are always displayed in the same arrangement.

4. A method according to claim 1, wherein the character options at the second level are always displayed in the same arrangement in dependence upon the character selected at the first level

5. (canceled)

6. A method according to claim 1, wherein the second character entry regions (1) are additionally activated at the second level.

7. (canceled)

8. A method according to claim 1, wherein the second character entry regions (1) are located above the first character entry regions (1).

9. A method according to claim 1, wherein the virtual keyboard includes a character display region (3) for displaying character options selected by a user.

10. A method according to claim 9, wherein the character display region (3) is located above the first and second character entry regions (1).

11. A method according to claim 1, wherein the first and second character entry regions (1) are arranged in an array.

12. A method according to claim 11, wherein the character entry regions (1) are arranged as four rows of regions with four regions in each row.

13. A method according to claim 11, wherein the character entry regions (1) are arranged as eight rows with two regions in each row.

14. A method according to claim 11, wherein the character entry regions (1) are arranged as two rows with eight regions in each row.
